(19) United States
(12) Patent Application Publication
(10) Pub. No.: US 2003/0188394 A1
(43) Pub. Date: Oct. 9, 2003

(54) Roller cage assembly with fixed roller sleeve

(76) Inventor: Michael J. Dove, Mission Viejo, CA (US)

Correspondence Address: COHEN & SAKAGUCHI LLP, 2424 SE BRISTOL STREET, SUITE 300, NEWPORT BEACH, CA, 92660, US

(21) Appl. No.: 10/276,533

(22) PCT Filed: Apr. 9, 2002
(86) PCT No.: PCT/US02/11057

(51) Int. Cl. B05C 17/02

(52) U.S. Cl. 15/230.11; 492/13; 492/19

(57) ABSTRACT

A roller cage assembly consisting of a primary and secondary hub. Each hub has an inner and outer surface. The inner surface of the primary hub and the inner surface of the secondary hub provides a compression fitting so that a longitudinal tube pressed into the said compression fitting on the primary inner hub and pressed into the said compression fitting on the secondary inner hub joins primary inner hub to secondary inner hub by said longitudinal tube and results in one complete unit. The circumference of the outer primary hub and the circumference of the secondary outer hub provided by a glue joint results in a seal to prevent liquids from entering the inner cavity of the roller cage assembly. These parts joined forms a unit, and represents the said roller cage assembly. This roller cage assembly provides the framework support for the paint roller sleeve. Together, the primary and secondary hub assembly joins the roller sleeve and together forms a fixed and immovable unit, the roller cage assembly.

This application involves the novelty of a paint roller cage assembly, providing the internal structure for a paint roller sleeve, and sleeve and cage assembly together becomes an inseparable complete paint roller assembly.

### BACKGROUND OF THE INVENTION

A typical paint roller, as contemplated for use in the instance of the present invention, comprises a handle, a rod extending from the handle, a cage rotate-ably attached to the rod shaft, the cage further having a handle end and a free end, a cylindrical shaped handle end cap affixed to the end of the cage where the shaft enters the cage from the handle, and a cylindrical shaped free end cap affixed to the other end of the cage where the shaft terminates. Each end cap is attached by four or so spring-biased axial rods that are outwardly bent. A hollow cylindrical paint roller is axially engage able along the shaft, whereby a friction fit interlock occurs between the spring-biased tension rods and the inner face of the cylindrical paint roller. A cylindrical paint roller or paintbrush (also known as a “cover” or “brush”) is affixed to and surrounds the cage and part of each end cap in such a manner that the roller or brush, end caps, and cage rotate together. In the normal course of operation, a user grasps the handle and dips the brush in a paint container so that its outer surface absorbs paint. The user then grasps the handle to manually apply the outer surface of the brush to the surface to be painted by rolling it against the surface. Hence the name, paint roller is denoted for its rolling characteristics over a presented surface.

Liquid applicators such as paint rollers have come into very widespread use due to their ability to apply coatings, usually paint, economically and quickly. Nearly every paint roller in commercial use today consists of a frame which terminates at one end in a handle and, at the other end in a cage and cover support rod, a cage received on the support rod, and a roller cover received on the cage. The term “roller” or “paint roller” when used herein will be used to refer to the just described components, namely (1) a frame having a handle and a support rod, (2) a cage and (3) a roller cover.

Operation of present day paint roller assemblies result in the roller element becoming increasingly harder to roll and decreased functionality of paint application occurs as the interior chamber of the roller element becomes loaded with paint, rotating assemblies clog and original intention of moving parts fail.

Thus, the development of the present invention. In short, the operation of the present day paint roller assemblies result in the following:

1. High production costs. Roller assemblies are largely made of a combination of materials. Most assemblies include wood, metal and plastic or just metal and plastic. The multiplicity of materials has a positive effect on production cost.

2. Intricate cage designs. Cage designs have become more complex through the years in an effort to prohibit the roller sleeve from moving away from desired position. This has caused undesirable expenses upon the originator of the product and the consumer.

3. Roller cage longevity. Due to the method that is presently used to join roller sleeve to cage assemblies, the roller cage is assaulted by chemicals and coatings causing clean-up impossibilities and undermining the working and moving parts of the cage. This bombardment relinquishes the mobility of the cage and restricts free movement decreasing the life of the cage and increasing the expense to the user due to frequent replacement of the cage.

4. Roller sleeve not staying in place. Considering the current methods of roller sleeve and cage connections, invariably the roller sleeve will not stay in its desired position. There is a flange or a stop on the handle side of the roller cage assembly to prevent roller sleeve movement, but due to the need to place and remove the roller sleeve, it is not possible to have a stop on the engaging end of the roller cage assembly. The present design then, has a built-in failure component that results in wandering roller sleeves. The sleeve wanders from its desired position.

5. Roller sleeve having to be cleaned inside after each use promotes decomposition of materials. With the sleeve wandering and sliding back and forth, paints attack the core element of the sleeve. Upon every use, liquid, whether water base or solvent base, must be used to clean and purge the interior core member of the roller sleeve. The continuous flood of liquid on this sleeve core, (which incidentally is made primarily of resin coated paper), looses shape and promotes delaminating of core. This premature decomposition forces replacement sooner than would ordinarily be necessary.

6. Paint professionals produce excessive waist discarding failing paint frames and roller sleeves sooner than need be. With the continuous bombardment of paints and liquids on cage and sleeve core, enormous waist is accumulated. Longevity of expensive roller frame assemblies and roller sleeves are cut to a minimum, cutting into profit and filling national land fills with un-needed waist.

7. At the close of each work-day, if proposed paint work is not completed, the roller frames assembly is submersed in paint liquids so that the assembly can be used the following work day. This avoids spending extra time day and prolongs the final cleaning until the paint job is fully completed. Each day, when the frames are used, the submersed paint frame assembly has absorbed paint liquids into the cage cavity to an undesirable degree, causing excessive weight to the frame assembly and un-wanted paint spewing out from each cage end-piece.

### SUMMARY OF THE INVENTION

1. Standard size roller cage assembly. The roller cage assembly is comparable to the size of standard roller cage assemblies already on the market. This means that the roller sleeve that attaches to the roller cage is also a standard size and the intended user is familiar with the capacities and defined abilities represented.

2. Production interests are not compromised due to the size of the roller cage. The roller cage will accommodate most standard roller sleeves that are presently on the market. Additionally, the paint professionals that use the existing roller cage assemblies and roller sleeves currently on the market will adapt to this invention easily. This invention complies with current production requirements of paint crews and paint teams nationally due to the standard size of the roller sleeve. Furthermore, this invention will exceed the present expectations that paint professionals have of their current devices.

3. The utility of the invention enables production of 7 inch, 9 inch or 12 inch cage assemblies without additional expense for multiple molds. Due to the design of the roller cage assembly, by shortening or increasing the length of the inner tube, the 7, 9 or 12 inch sleeve can be accommodated. This decreases the die costs involved in production of the product and hence reduces the expense of the final product to the consumer.

4. The roller sleeve is locked into a fixed position. The roller sleeve is pinned between the roller sleeve stop on each hub. This locks the sleeve into an immovable position.

5. Liquid transfer into the cavity of the cage is prevented which enhances the life of the roller sleeve. With the sleeve locked into position, liquid transfer is reduced, but with the roller sleeve glued into position on the hub, liquid transfer is practically eliminated. Additionally, the transfer reduction cap reduces liquid from entering the central passageway. Without liquid entering the cavity of the roller cage assembly and the central passageway, causing liquid to constantly attack the interior core of the sleeve, the longevity of the roller sleeve is sustained. The replacement of the roller sleeve is held to a minimum.

6. The longevity of the cage is promoted. Due to the elimination of liquid transfer into the cavity of the roller cage assembly, the cage maintains the composure and integrity of its origination.

8. Production costs are limited. Each hub is exactly similar. One mold produces the inner and outer hub. This reduces the cost of production and hence the consumer saves on product purchases.

### BRIEF DESCRIPTION OF THE DRAWINGS

The following are descriptions which numerals correspond to the drawing:

FIG. 1 is an exploded sectional view of the disassembled elements which in their assembled form represent the cage assembly;

FIG. 2 is a fragmentary sectional view showing the relationship between the tube, the compression member of the inner hub and the rod keeper inside the hub;

FIG. 3 is a sectional view showing internal parts of a paint roller containing the embodiment of the present invention, the roller sleeve in locking position against hub stops, and the roller cage assembly being intercoursed by the frame rod through the central passageway of the hub;

FIG. 4 is a sectional view showing internal parts of a paint roller containing the embodiment of the present invention including the plastic handle, the roller cage assembly rotate-able about the axis of the rod frame;

FIG. 5 is a sectional view of the primary hub assembly;

FIG. 6 is a sectional view of the secondary hub assembly;

### DETAILED DESCRIPTION OF THE DRAWINGS EMBODIMENTS

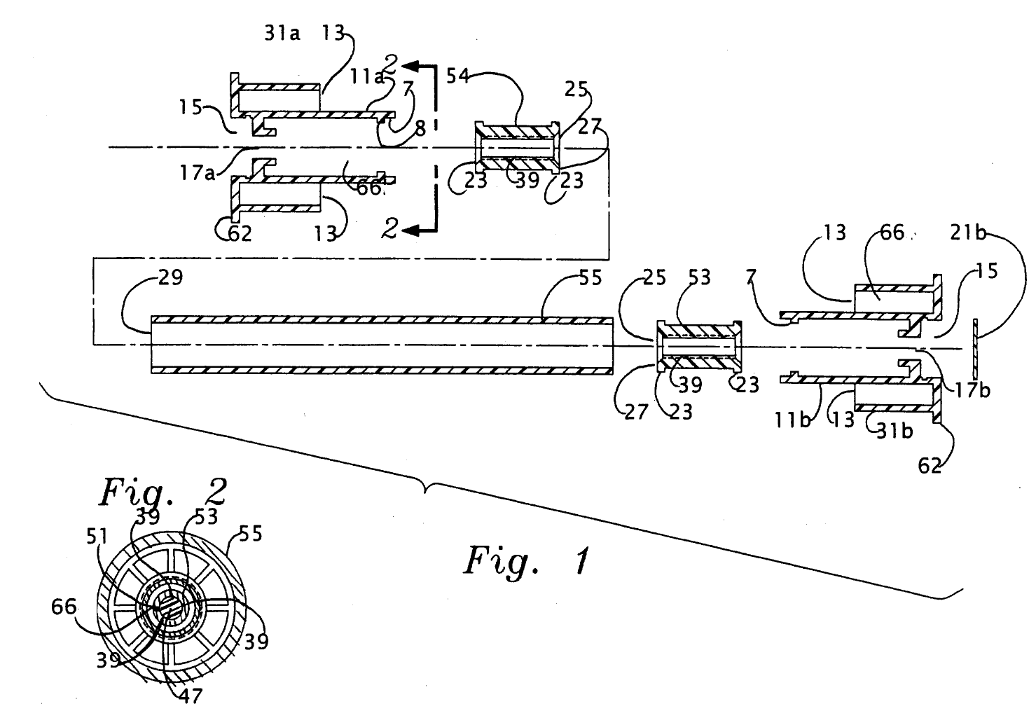

FIG. 1 is an exploded sectional view of the disassembled elements which in their assembled form represent the cage assembly;

15 is the cylindrical opening which leads into the opening of 17a, the opening and diameter to receive rod, FIG. 1 65. The rod intercourses 17, the cavity of 66, feels the resistance of the inner wall 39 of keeper 54, penetrates and enters the cavity of 29 freely, feels the resistance again of the inner wall 39 of keeper 53, penetrates and enters the cavity of the secondary hub cavity 66 and terminates penetration by ending at 17b.

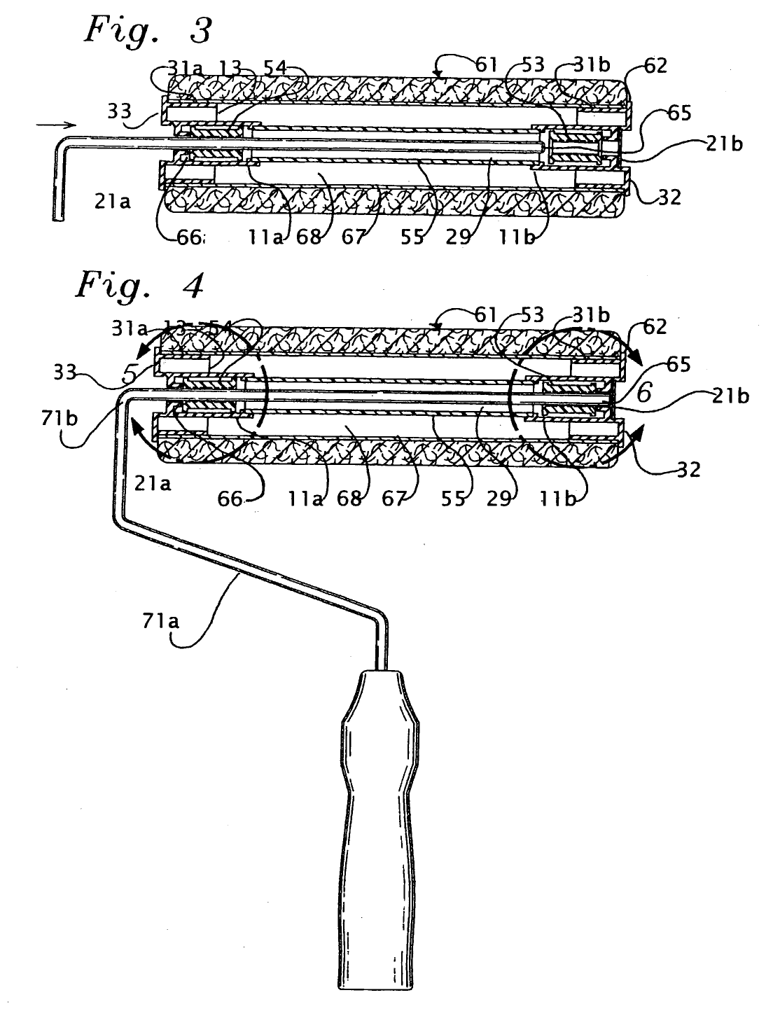

31a and 31b shows the surface of a cross-section of primary and secondary hub. This surface is held into position by compression and a glue joint at 31a and 31b, to produce a snug fit at the interior surface of roller sleeve, FIG. 3 67. This snug fit reduces the risk of liquid transfer into cavity FIG. 3 68.

The inner primary hub 11a provides the housing for the receptacle shown at 7 and 8. Receptacle 7 provides the opening to receive the tube 55 and 8 provides the stop for the termination of tube 55. The joint where tube 55 and 7 and 8 meet is sealed with glue to prevent liquid transfers into inner cavity, FIG. 3 68.

62 shows the stop which prevents the movement of the roller sleeve FIG. 3 67 and forces the sleeve to stay into an immovable position. This stop is formed into the primary and secondary hub and locks the roller sleeve in place. The rod, FIG. 3 65 moves freely in the cavity of 55, noted by 29.

FIG. 3

Showing in FIG. 3 are two hubs, 33 is the outer primary hub and 32 is the outer secondary hub, the primary hub located on the left side of the drawing shown and the secondary hub located on the right side of the drawing shown. The roller sleeve terminates onto each hub, primary and secondary. The sleeve is held into position, fixed and immovable, by 62, outer hub stop. 62 is a flange on each hub, primary and secondary, forcing the roller sleeve into a fixed position. The sleeve also has pressure placed where inside of roller sleeve 67, rests against 31a, roller sleeve support and hub surface. The surface of 31a provides a friction fit against the inside of the roller sleeve 67. This friction fit is bonded by glue, placed at 31a for the primary hub and at 31b for the secondary hub. This glue placement provides a tight fit to reduce liquid transfer into the roller sleeve cavity 67.

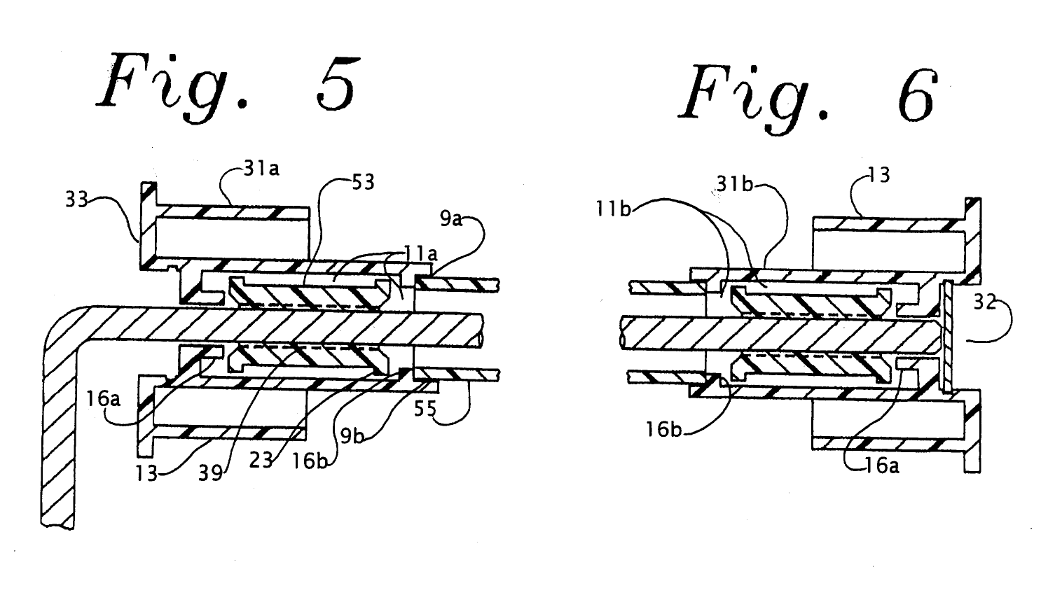

31a primary hub and 31b secondary hub, provides the housing for 54, primary keeper and 53, secondary keeper. The keepers are held into position within the hub cavity FIG. 5 11a and FIG. 6 11b. The inner hub cavity wall 66a and the tube stop interior, FIG. 5 16b, maintain the keeper and prevent the keeper from wandering excessively from side to side.

The rod 65, intercourses each keeper without excessive resistance, due to its tapered end. After rod 65, intercourses keeper 54 and 53 into the full position shown in diagram FIG. 4, the intercourse surface of the exterior rod surface and the interior keeper surface, FIG. 5 39 holds tight. The keepers grip the rod such that rod resists slipping out of position shown in FIG. 4.

11a is the inner portion of the primary hub and 11b is the inner portion of the secondary hub. The inner portion of the hub provides the compression cavity that holds tube 55 into a fixed position.

FIG. 5 and FIG. 6 is a fragmentary sectional view showing the relationship between the tube, the compression cavity of the inner hub and the rod keeper inside the hub;

The hub cavity 11a provides space for the keeper 53 to move freely. When the rod FIG. 3 65, intercourses into position through the keeper 53, the hub 31a and 31b with roller sleeve 61, rotate around the keeper and rod.

FIG. 5 further shows the relationship the keeper lip 23 and the tube stop interior 16b. This relationship provides a stopping point for the keeper to minimize slop in the roller frame assembly. The interior keeper wall 39 is smooth and maintains a diameter less than the rod, FIG. 3 65, to produce a tight intercourse. 9a is the tube stop exterior. This stop prevents the tube 55 from enclosing upon the inner hub cavity 38 and threatening the mobility of the keeper 53. 9b enables pressure on all sides of the tube 55 and fits tightly along with glue as to produce a connection that will not allow liquid transfer. The rod, FIG. 3 65, fits loosely into 29. This loose fit provides mobility of 29 rotation around FIG. 3 65.

FIG. 4

As in FIG. 3, FIG. 4 shows two hubs, 33 is the outer primary hub and 32 is the outer secondary hub, the primary hub located on the left side of the drawing shown and the secondary hub located on the right side of the drawing shown. The roller sleeve terminates onto each hub, primary and secondary. The sleeve is held into position, fixed and immovable, by 62, outer hub stop. 62 is a flange on each hub, primary and secondary, forcing the roller sleeve into a fixed position. The sleeve also has pressure placed where inside of roller sleeve 67, rests against 31a, roller sleeve support and hub surface. The surface of 31a provides a friction fit against the inside of the roller sleeve 67. This friction fit is bonded by glue, placed at 31a for the primary hub and at 31b for the secondary hub. This glue placement provides a tight fit to reduce liquid transfer into the roller sleeve cavity 67. However, shown here in FIG. 4 that differs from FIG. 3, is the full engagement of roller rod, 71 which terminates with cap 21b. 21b prevents liquid transfer into tube cavity 29.

71b shows the bent angle of the rod that intercourses the longitudinal length of the cage and ending at 21b. The roller sleeve, FIG. 3 61, is held in place by the pressure produced by friction of 31a and 31b hub. 21a and 21b shows the rubber o-ring or formed plastic o-ring placement. Due to the irregularity of roller sleeve inner surface, 31a and 31b applies pressure to the inner surface to reduce liquid transfer into sleeve cavity FIG. 3 68.

The assembled cage shown in this diagram (FIG. 4), rotates upon the axis of rod FIG. 4 65 freely without slipping off the rod, FIG. 4 65, held tightly by the keepers, FIG. 2 53. This rotation is exemplified by the cross-section as noted FIG. 2, and in FIG. 2, 39 shows the inside diameter of the keeper with pressure applied upon 47, a cross-section of the rod.

Furthermore, the outside diameter of the keeper 53 and the hub cavity 66 allows free rotation and mobility of the keeper inside the cavity. The gap in the keeper 53 as shown by 51 allows intercourse between the rod 47 and the keeper wall 39 and expands necessarily for diameter of 47 but maintaining tight grip. 55 shows the wall of the hub that provides the support for the inner keeper mechanisms.

When the cage in these diagrams are joined together, the complete union represents the cage assembly and it will be understood that the embodiments shown herein are examples of the invention, and it will be apparent to those skilled in the art that numerous variations and modifications may be applied without departing from the spirit and scope of the invention as defined in the appended claims. Therefore, the scope of the invention should not be judged by the foregoing descriptions but instead by the scope of the appended claims as interpreted in accordance with applicable law.

I claim:

1. A cage for a paint roller consisting
Of a primary and secondary hub, each hub exactly similar, and each hub consisting of an inner and outer portion.

2. A cage in accordance with claim 1 whereby:
Inner hub having a central passageway for receiving a rod in a loose-fitting manner which allows free rotation of said cage about said rod.

3. A cage in accordance with claim 2 whereby:
Said rod intercourses a plastic keeper held in place by a cavity in the central passageway of each hub, one intercourse per each keeper.

4. A cage in accordance with claim 1 whereby:
Each hub is connected by a tube

5. A cage in accordance with claim 4 whereby:
The tube connects the inner portion of primary hub and secondary hub. Tube connection is held in place by compression, compression fitting is an integral part of each hub.

6. A cage in accordance with claim 4 whereby:
Tube ends impale each hub inner portion and held in position by compression

7. A cage in accordance with claim 1 whereby:
The primary and secondary hubs have a roller sleeve stop for engaging tubular roller core, said stop is formed to the outer portion of the primary and secondary hub, each stop exactly similar and said stop holds tubular core in place.

8. A cage in accordance with claim 7 whereby:
The stops are an integral and inseparable part of the hub, formed as a part of the hub and inseparable.

9. A cage used as a housing and internal workings form the foundation, including a handle, and support rod connected to said handle and extending along an axis, and a tubular roller sleeve having an absorbent exterior surface to result in applying a liquid surface, said cage comprising of two hubs which are exactly similar having an inner and outer surface, the outer surface comprising of a stop, each hub connected at inner portion by a tube, tube ends impale each inner hub portion and held in position by compression, compression fitting an integral part of each hub and together forming an integral and inseparable cage, rotateable by the said rod, in which said rod intercourses through a plastic keeper held in place about a cavity in the central passageway of the hub, one keeper per hub, and penetrated keeper within hub enables roller sleeve and cage assembly to move freely about the intercoursed keeper.
